(19) United States
(12) Patent Application Publication
(10) Pub. No.: US 2008/0149425 A1
(43) Pub. Date: Jun. 26, 2008

(54) TIRE LIFT

(76) Inventor: Patrick C. Lucy, Sedona, AZ (US)

Correspondence Address: Mark J. Burns;HAUGEN LAW FIRM PLLP, Suite 1130, 121 South Eighth Street, Minneapolis, MN, 55402, US

(21) Appl. No.: 11/613,343

(22) Filed: Dec. 20, 2006

(51) Int. Cl. B66F 7/28

(52) U.S. Cl. 187/217

(57) ABSTRACT

A tire lift is provided for use in operably lifting and lowering tires. An upstanding member extends from a base to define a substantially vertical hoist axis. An extension arm having a proximal portion and an opposed distal portion defines a longitudinal axis extending therebetween. The proximal portion is movably engaged to the upstanding member while the distal portion is specifically configured to operably receive a tire in an orientation such that a central axis of the tire is substantially divergent from the longitudinal axis of the extension arm. A positioning device allows the extension arm to be selectively positioned along the hoist axis.

### FIELD OF THE INVENTION

The present invention relates generally to the field of tire lifts and tire caddies for assisting in the lifting and positioning of a tire and wheel assembly about a vertical dimension. More specifically, the invention relates to a tire lift assembly that is configured to provide improved access by the assembly operator to the tire.

### BACKGROUND OF THE PRIOR ART

The prior art provides a number of apparatus for lifting of a tire and wheel assembly. Such apparatus generally include a base having an upstanding member extending therefrom to define a generally vertical axis. A tire support frame extends from the upstanding member to define a generally horizontal axis. The tire support frame is coupled to the upstanding member by a positioning device such that the tire support frame may be adjusted vertically with respect to the upstanding member. In such prior art devices, the tire is oriented on the tire support frame such that a central axis of the tire is substantially parallel to the horizontal axis of the tire support frame.

A problem with these prior art devices is that the upstanding member and tire support frame obstruct an operator from efficiently accessing the tire, such as for moving the tire from the tire lift to a tire analysis mechanism, such as a tire balancer. For maximum leverage, it is preferable that an operator square his or her body with respect to the tire. However, in such prior art devices, this requires that the operator reach around opposing sides of the upstanding member to squarely access opposing sides of the tire. Alternatively, the operator may be positioned on a single side of the tire support frame. Such positioning of the operator provides access to the section of the tire extending on the same side of the tire support frame, but renders the remainder of the tire essentially inaccessible. In either case, the upstanding member and the tire support frame of the prior art devices obstruct access to the tire and adversely affect the leverage available to an operator in accessing the tire.

It would, therefore, be advantageous to provide a tire lift that overcomes these and additional problems of the prior art.

### SUMMARY OF THE INVENTION

The present invention provides a tire lift that functions as a hoist mechanism for use in operably lifting and lowering a tire and wheel assembly. The tire lift has a base with an upstanding member extending therefrom to define a substantially vertical hoist axis. An extension arm extends from a proximal portion to a distal portion to define a longitudinal axis extending therebetween. In preferred embodiments, the longitudinal axis of the extension arm is substantially perpendicular to the vertical hoist axis. The proximal portion of the extension arm is movably engaged to the upstanding member such that the height of the extension arm may be selectively adjusted along the hoist axis. The distal portion of the extension arm is configured to operably receive a tire and wheel assembly in an orientation such that a central axis of the tire is perpendicular to the longitudinal axis.

It is an object of the present invention to provide a tire lift that allows a tire and wheel assembly removably mounted thereon to be easily accessed with minimal obstruction from the upstanding member and the extension arm.

It is a further object of the present invention to provide a tire lift that allows the tire to be selectively hoisted to a plurality of positions along a hoist axis.

It is yet another object of the present invention to provide a tire lift that operably enables an operator to utilize an increased degree of manipulative leverage when accessing a tire and wheel assembly positioned thereon.

### BRIEF DESCRIPTION OF THE DRAWINGS

FIG. 1 is a perspective view of a tire lift apparatus in accordance with the present invention.

FIG. 2 is a perspective view of a tire lift apparatus in accordance with the present invention.

FIG. 3 is a perspective view of a tire lift apparatus in accordance with the present invention.

### DETAILED DESCRIPTION OF THE PREFERRED EMBODIMENTS

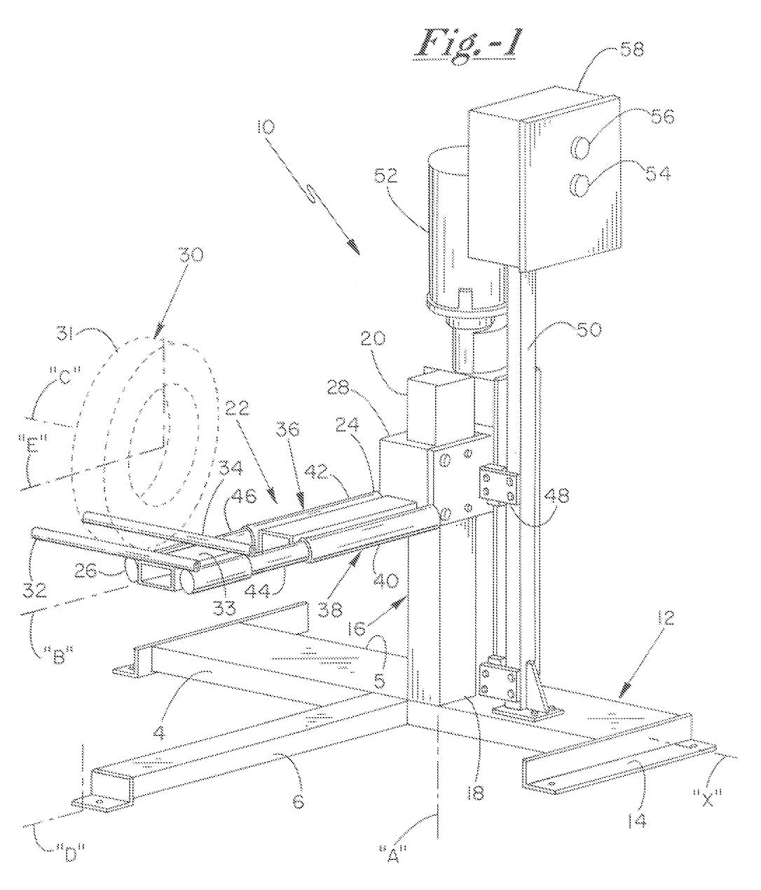

FIG. 1 illustrates a tire lift 10 having a base 12, which in the present embodiment includes a plurality of mounting plates 14 for mounting the base 12 to a horizontal surface, such as a floor surface. Mounting plates 14 may instead be useful for providing a location of base 12 at which to mount casters or other mechanisms to render tire lift 10 mobile.

As illustrated in FIG. 1, base 12 preferably includes a first elongated main member 4 and a second support member 6 extending laterally from main axis “X” of main member 4. Base 12 is preferably fabricated from a strong and relatively dense material, such as steel, so that base 12 provides a stable support for the remainder of tire lift 10.

An upstanding member 16 extends from main member 4 of base 12, and has opposing first and second ends 18, 20 defining a substantially vertical hoist axis “A” therebetween. First end 18 is preferably fixed to base 12 through securement means such as fasteners, welds, and the like.

An extension arm 22 has a proximal portion 24 and an opposing distal portion 26, such that the extension arm 22 defines a longitudinal axis “B” extending along a plane substantially parallel to base 12. In preferred embodiments, longitudinal axis “B” is substantially horizontally oriented. The proximal portion 24 of the extension arm 22 is movably engaged to the upstanding member 16 by a positioning device 28 slidably coupled to the upstanding member 16. In operation, the extension arm 22 may be selectively positioned along the hoist axis “A” by movement of the positioning device 28 about the upstanding member 16.

A variety of mechanisms may be useful in positioning device 28 to selectively lift and lower extension arm 22 along hoist axis “A”. It is well known in the art of tire hoists to utilize an electrical motor to manipulate the elevation of the tire and wheel assembly. Other driving mechanisms for operably raising and lowering extension arm 22 include air motors and manual lifters.

The distal portion 16 of the extension arm 22 is specifically configured to receive a tire and wheel assembly 30 such that the central axis “C” of the tire 30 is operably oriented perpendicularly with respect to the longitudinal axis “B” of extension arm 22. In the present embodiment, the distal portion 26 includes a pair of support members 32, 34 aligned perpendicularly to the longitudinal axis “B”. Support members 32, 34 are preferably spaced apart to define a reception cradle 33 at which the tire 30 may be operably positioned such that the axis “C” of the tire 30 extends substantially parallel to the respective elongate axes of the support members 32, 34.

In preferred embodiments, tire 30 is operably positioned such that a portion of outer circumferential surface 31 of tire 30 is mounted at reception cradle 33 in the orientation illustrated in FIG. 1. Accordingly, reception cradle 33 may be formed by structures other than first and second support members 32, 34. For example, reception cradle 33 may be formed by a single elongated arcuate member, or by a series of discontinuous arcuate members. Reception cradle 33 may therefore comprise a variety of configurations which enable the operable support of tire 30 in an orientation such that axis “C” is at least substantially divergent from longitudinal axis “B” of extension arm 22, and preferably substantially perpendicular thereto. While reception cradle 33 is preferably configured to support an outer circumferential surface of tire 30, reception cradle 33 may instead or additionally be utilized to support tire 30 from within a central aperture of tire 30. In this embodiment, support members 32, 34, for example, act to lift tire and wheel assembly 30 at an inner circumferential surface thereof.

The extension arm 22 may further include a telescoping capability. As shown in FIG. 1, one or more outer sleeves 40, 42 extend from the proximal portion 24 of the extension arm 22, each having an inner post 44, 46 slidably received therein. An operator may, therefore, selectively extend or retract inner posts 44, 46 with respect to outer sleeves 40, 42 to adjust the total length of extension arm 22 along the longitudinal axis “B” between an extended configuration and a retracted configuration.

Where the hoist axis “A” and longitudinal axis “B” may be said to together define a plane “D”, the support members 32, 34 may protrude from extension arm 22 in a direction extending perpendicularly to plane “D”, such that the tire 30 is operably supported in a first position on a first side 36 of plane “D”. In other embodiments, the tire 30 may be supported by the support members 32, 34 in a second position such that a plane “E” of tire 30 is substantially coextensive with longitudinal axis “B”. Reception cradle 33 may therefore be configured to receive tire 30 in either or both of the first and second positions.

The positioning device 28 enables the extension arm 22 to move along the hoist axis “A” through the use of a tab 48 connecting the positioning device 28 to a lead screw 50. The direction of rotation of the lead screw 50 functions to selectively raise and lower the positioning device 28 with respect to the upstanding member 16. As shown in FIG. 1, motor 52 is used to rotate the lead screw 50. Actuators 54, 56 are depressed by the operator to selectively enable movement of the positioning device 28 and, thus, corresponding movement of the extension arm 22 with respect to the hoist axis “A”.

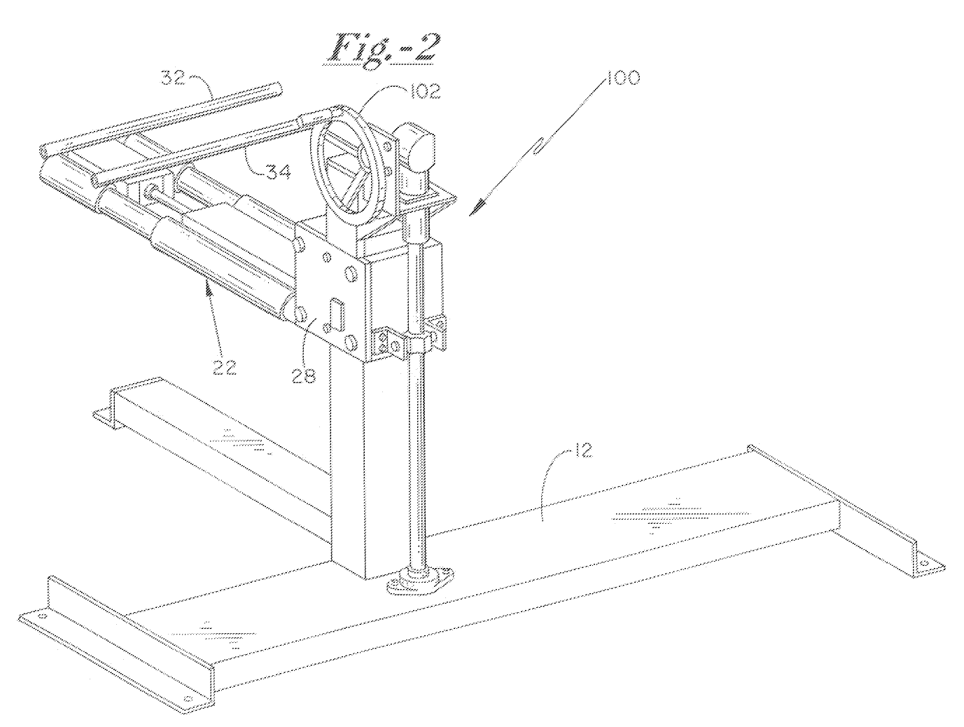

FIG. 2 shows a manually operated tire lift 100 wherein the lead screw 50 is rotated by manually turning a crank 102 which, in turn, results in the selective rotation of the lead screw 50 and corresponding raising and lowering of the extension arm 22 with respect to the hoist axis “A” as discussed with reference to FIG. 1.

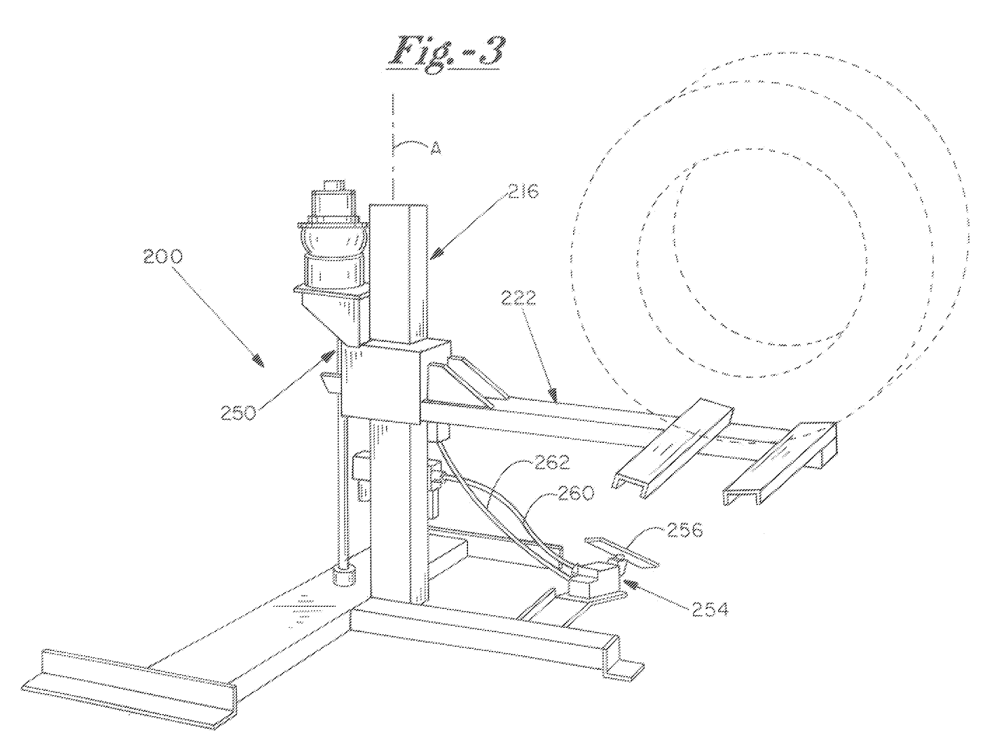

FIG. 3 depicts a tire lift 200 that is substantially analogous to tire lift 10 illustrated in FIG. 1, but with extension arm 222 being driven along upstanding member 216 through an air-driven motor. To control the operation of lead screw 250, a foot-operated actuator 254 may be provided. As such, manipulation of a foot pedal 256 in a first direction causes air to be driven through the motor so as to force lead screw 250 to rotate in a first direction, while manipulation of foot pedal 256 in a second direction, such as opposite of the first direction, causes air to be driven through the motor so as to force lead screw 250 to rotate in a second direction. Communication from actuator 254 to the air motor may be effectuated through air lines 260, 262. Accordingly, selective operation of foot actuator 254 effectuates raising and lowering of extension arm 222 along hoist axis “A”.

An adjustment mechanism, similar to that discussed with reference to FIGS. 1-3 for selectively raising and lowering the extension arm with respect to the hoist axis “A”, is disclosed in U.S. Pat. No. 5,427,493 issued to the present Applicant and herein incorporated by reference in its entirety. Such a mechanism is effective in allowing the positioning device to smoothly move along axis “A” without binding. Since the extension arm is cantilevered out from the upstanding member by a substantial distance, and since tire 30 is operably placed at a distal end thereof, a relatively large torque is developed at the positioning device. The developed torque has the tendency to bind the nut mounted about the rotating screw. The system described in U.S. Pat. No. 5,427,493 ameliorates such a binding tendency. In addition, the positioning device may be further fitted with mechanisms for aiding in the slidability of the positioning device along hoist axis “A”. Examples of such mechanisms include rollers, bushings, and the like.

The arrangement of the various components of tire lifts 10, 100, 200 as described above significantly enhance the operator's ability to manipulate tire 30 when tire 30 is disposed at the tire lift. In particular, the upstanding member defining hoist axis “A”, the motor, and the actuators are preferably substantially spaced from reception cradle 33, such that tire 30 is operably spaced from the control and lifting mechanisms of the tire lift. In preferred embodiments, reception cradle 33 is spaced from the upstanding member by at least about 30 cm.

The optional telescoping capability of extension arm 22 enables reception cradle 33 to be selectively positioned along axis “B” from between about 30 and 150 cm from upstanding member 16. Such a spacing enables outer circumferential surface 31 of tire 30 to be spaced from upstanding member 16 when operably disposed at reception cradle 33 and prevents obstruction from the upstanding member 16 when accessing the tire 30.

In addition to the spacing characteristics described above, tire lift 10 is specifically configured, as at reception cradle 33, so as to operably retain tire 30 in an orientation such that central axis “C” of tire 30 is divergently oriented with respect to longitudinal axis “B” of extension arm 22. Through such an arrangement, an operator may access tire 30 in facing relationship with a diameter dimension of tire 30. Such a relative facing relationship greatly enhances operator leverage upon tire 30, in that the operator may readily grasp substantially diametrically opposed sides of outer circumferential surface 31 of tire 30. This grasping arrangement facilitates efficient manipulation of tire 30, such as in mounting and dismounting tire 30 to a vehicle, tire balancer, or other apparatus that involves mounting tire 30 in an upright orientation.

Tire lift 10 further assists the operator in accessing and manipulating tire 30 through a preferred configuration of base 12. As described above, base 12 includes an elongated main member 4 that, in conjunction with mounting plates 14, provide, to a large extent, stable support for tire lift 10. Due to the cantilevered configuration of extension arm 22 upon which tire 30 is operably mounted, second support member 6 preferably extends laterally from main member 4 in a direction from upstanding member 16 consistent with extension arm 22. As such, second support member 6 supports the cantilevered weight of extension arm 22 and tire 30. However, it is an important aspect of the present invention that second support member 6 extend laterally from main member 4 at a portion thereof that does not inhibit access by an operator to tire 30. Specifically, one aspect of the present invention is for the operator to be able to stand immediately adjacent to extension arm 22 in facing relationship with a diameter dimension of tire 30 without standing upon base 12. As such, second support member 6 laterally extends from distal portion 5 of main member 4. Applicant has found that such a position for second support member 6 sufficiently stabilizes tire lift 10 in operation. It is further contemplated by the present invention that base 12 may be variously configured to adequately support tire lift 10. However, it is an important aspect of the present invention that the configuration of base 12 not interfere with the operator's ability to stand immediately adjacent to extension arm 22, and preferably at second side 38 of plane “D” so as to readily grasp and manipulate tire 30 disposed at reception cradle 33.

It is understood that the various embodiments of the present invention are illustrative and not limiting as to the scope and spirit of the present invention.

What is claimed is:

1. A hoist mechanism for use in operably lifting and lowering tires, said hoist mechanism comprising:
a) a base;
b) an upstanding member extending from said base and defining a substantially vertical hoist axis;
c) an extension arm having a proximal portion and an opposed distal portion defining a longitudinal axis extending therebetween, said proximal portion being movably engaged to said upstanding member, and said distal portion being specifically configured to operably receive a tire in an orientation such that a central axis of said tire is substantially divergent from said longitudinal axis of said extension arm; and
d) an elevation control device for selectively moving said proximal portion of said extension arm along said hoist axis.

2. A hoist mechanism as in claim 1, including a tire reception cradle disposed at said distal portion of said extension arm.

3. A hoist mechanism as in claim 2 wherein said tire reception cradle comprises a pair of spaced support members extending perpendicularly with respect to said extension arm.

4. A hoist mechanism as in claim 2 wherein said extension arm is selectively extendable.

5. A hoist mechanism as in claim 2 wherein said extension arm is telescopingly extendable.

6. A hoist mechanism as in claim 2 wherein said tire reception cradle is spaced from said upstanding member by at least about 30 cm.

7. A hoist mechanism as in claim 2 wherein said extension arm is movable with respect to said upstanding member by a motorized lift mechanism.

8. A hoist mechanism as in claim 2 wherein said extension arm is movable with respect to said upstanding member by a manually operated lift mechanism.

9. A hoist mechanism as in claim 2 wherein said extension arm is movable with respect to said upstanding member through a air motor lift mechanism.

10. A hoist mechanism as in claim 1 wherein both said longitudinal axis of said extension arm and said central axis of said tire are oriented substantially horizontally.

11. A hoist mechanism as in claim 10 wherein said central axis of said tire is perpendicular to said longitudinal axis of said extension arm.

12. A method for lifting a tire, said method comprising the steps of:
(a) positioning said tire at an extension arm such that a central axis of said tire is substantially divergent from a longitudinal axis defined by said extension arm, said extension arm being movably engaged to an upstanding member defining a hoist axis;
(b) lifting said tire by operably adjusting said extension arm with respect to said upstanding member.

13. A method as in claim 12 wherein said central axis of said tire and said longitudinal axis of said extension arm are oriented substantially horizontally.

14. A method as in claim 13 wherein said central axis of said tire is perpendicular to said longitudinal axis of said extension arm.
